(19) United States
(12) Patent Application Publication
(10) Pub. No.: US 2005/0155225 A1
(43) Pub. Date: Jul. 21, 2005

(54) Match lapping valve assemblies

(76) Inventor: Lionel J. Milberger, Houston, TX (US)

Correspondence Address: BAKER BOTTS, LLP, 910 LOUISIANA, HOUSTON, TX, 77002-4995, US

(21) Appl. No.: 11/033,705

(22) Filed: Jan. 12, 2005

Related U.S. Application Data
(60) Provisional application No. 60/536,750, filed on Jan. 15, 2004.

(51) Int. Cl. B21K 1/20; B23P 17/00

(52) U.S. Cl. 29/890.132

(57) ABSTRACT

A method for match lapping a ball valve assembly including a ball and a seat, the method having the following steps: contacting the seat with the ball; rotating the ball about a first rotational axis; rotating the seat about a second rotational axis; and changing an angle formed at the intersection of the first and second rotational axes. The method may include applying lapping compound to one or both of the seat and ball.

### SUMMARY OF THE INVENTION

In general, in one aspect, this invention features a method for match lapping a ball valve assembly. The ball valve assembly may include a ball and a mating seat. The method may include placing a seat on a ball and applying a lapping compound to one or both of the seat and the ball. The method may also include rotating the ball about a first rotational axis, rotating the seat about a second rotational axis, and articulating the seat relative to the ball.

According to one aspect of the invention, there is provided a method for match lapping a ball valve assembly including a ball and a seat, the method having the following steps: contacting the seat with the ball; rotating the ball about a first rotational axis; rotating the seat about a second rotational axis; and changing an angle formed at the intersection of the first and second rotational axes.

Another aspect of the invention provides a method for match lapping a ball valve assembly including a ball and a seat, the method having steps as follows: rough machining the ball and the seat to within about 0.010 and about 0.020 inches of the desired finished sizes; grinding the ball and the seat to within about 0.001 and about 0.002 inches of the desired finished sizes; contacting the seat with the ball; rotating the ball about a first rotational axis at a rotational speed between about 10 and about 60 revolutions per minute (RPM) and changing the direction of rotation; rotating the seat about a second rotational axis at a rotational speed between about 10 and about 60 revolutions per minute (RPM) and changing the direction of rotation; applying a first lapping compound comprising an abrasive of a first size to one of the seat and the ball; washing first lapping compound from the seat and the ball; applying a second lapping compound comprising an abrasive of a second size to one of the seat and the ball, wherein the first size is larger than the second size; washing the second lapping compound from the seat and the ball; and changing an angle formed at the intersection of the first and second rotational axes by increasing the angle and decreasing the angle.

Still another aspect of the invention provides a ball valve assembly having a ball and a seat manufactured by a method, the method having the following steps: contacting the seat with the ball; rotating the ball about a first rotational axis; rotating the seat about a second rotational axis; and changing an angle formed at the intersection of the first and second rotational axes.

### BRIEF DESCRIPTION OF THE DRAWINGS

A more complete understanding of the present disclosure and advantages thereof may be acquired by referring to the following description taken in conjunction with the accompanying drawings wherein:

FIG. 1 is a flow diagram of an example method for match lapping a ball and seat according to the present invention;

FIG. 2 is an embodiment showing the relative motion of a ball and a seat during performance of a match lapping technique according to the present invention;

FIG. 3 is a flow diagram of an example method for match lapping a ball and seat having a coating layer in accordance with the present invention; and

FIG. 4 is an embodiment showing the relative motion of a ball and two seats during performance of a match lapping technique according to the present invention.

The present invention may be susceptible to various modifications and alternative forms. Specific embodiments of the present invention are shown by way of example in the drawings and are described herein in detail. It should be understood, however, that the description set forth herein of specific embodiments is not intended to limit the present invention to the particular forms disclosed. Rather, all modifications, alternatives and equivalents falling within the spirit and scope of the invention as defined by the appended claims are intended to be covered.

### DETAILED DESCRIPTION OF SPECIFIC EMBODIMENTS

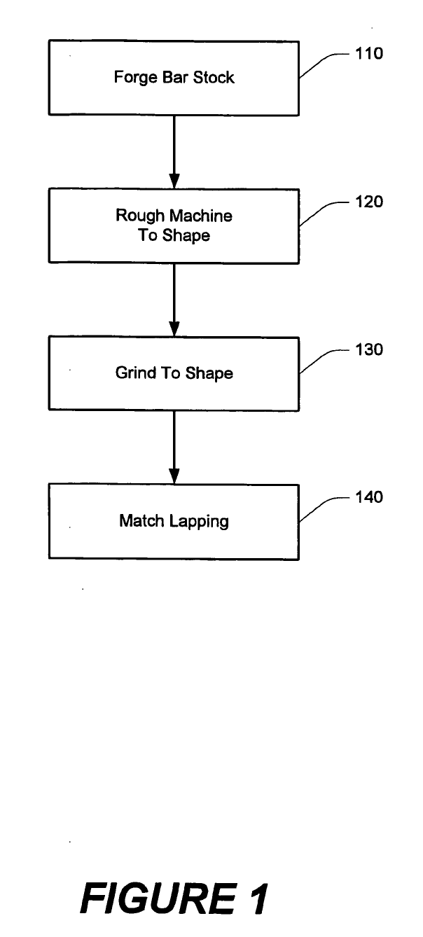

The details of the present invention will now be described with reference to the figures. One embodiment of a method for match lapping a ball and seat is depicted in FIG. 1. The method includes forging a ball and seat from bar stock of appropriate size (block 110). The forged bar stock may be rough machined to the respective shape of the ball or seat (block 120). Next, the ball and seat may be ground to a more precise shape that is close to the finished size (block 130). Finally, match lapping may be used to form a tight seal between the ball and seat (block 140).

In one embodiment, the ball and the seat may comprise stainless steel such as Inconel®. The ball and the seat may further comprise a coating layer. The coating layer may comprise, inter alia, tungsten carbide or stellite. The disclosed methods should be preferably used with a ball that does not include trunions. Any non-integral trunions, e.g., bars or burrs, protruding from the surface of a ball may be removed by grinding. A ball may further comprise a bore. The bore may be used to hold the ball in place during machining. The seat may also include a bore. The disclosed match lapping process seeks to obtain a tight seal between the wall of the seat and the ball.

In one embodiment, rough machining (block 110) may be used to machine the ball and seat to within about 0.010-0.020 inches of finished size. A ball and seat may be further ground (block 130) to a more precise size of about 0.001-0.002 inches of finished size. The grinding step should not score the ball or seat and may be performed to within an RMS of about 8. Furthermore, a preferred match lapping step (block 140) may remove about 0.001-0.002 inches of material to produce a ball and seat of desired size and having a desired seal.

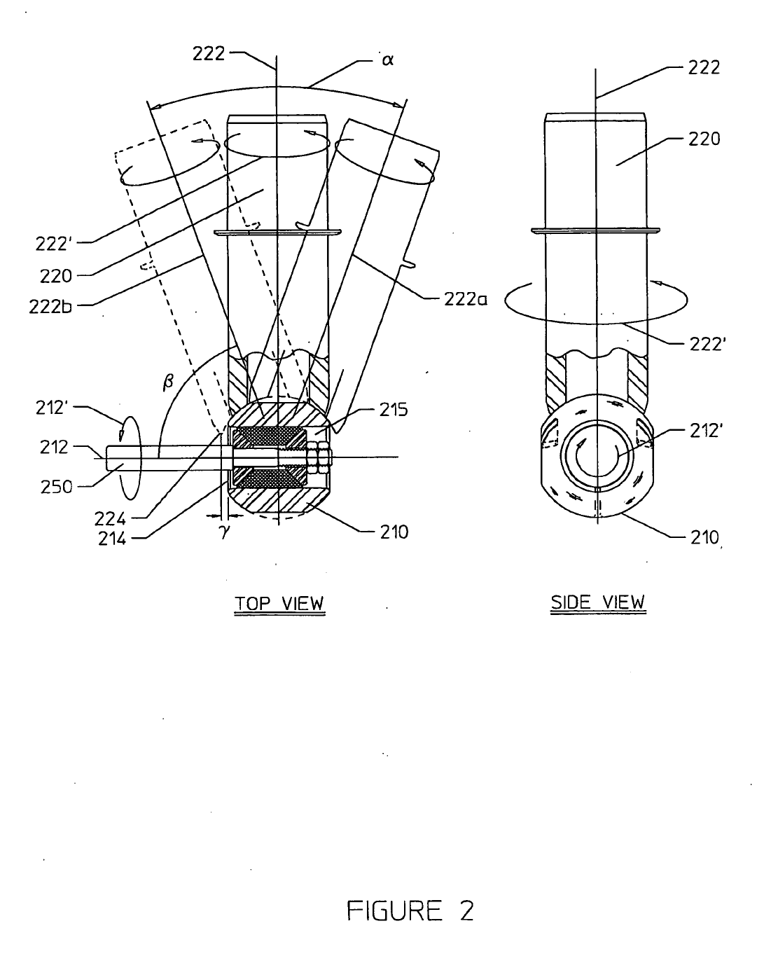

One example embodiment of a method for match lapping a ball and seat is shown in FIG. 2. A top view showing one example relative motion for match lapping a ball and seat is shown in FIG. 2A, and a corresponding side view is shown in FIG. 2B. The example lapping process shown in FIGS. 2A and 2B includes two axes of continuous rotation and one axis of partial rotation. Ball 210 may be rotated about a first rotational axis 212. For example, fixture 250 may be inserted into the bore 215 of ball 210, and fixture 250 may be rotated about a first rotation axis 212 in the direction denoted by arrow 212′. Seat 220 may be rotated about a second rotational axis 222 in a direction denoted by arrow 222′. The first axis of rotation may be perpendicular to the second axis of rotation. Furthermore, seat 220 may be articulated within the angle denoted by α. For example, the seat may be partially rotated about a third axis, which may be perpendicular to both the first and second axes of rotation. As a result, the angle formed by the intersection of the first and second rotational axis may range from about β to about α+β.

In some embodiments of the invention, ball 210 may be rotated about a first rotational axis 212 in both directions. For example the ball may first be rotated in the direction denoted by arrow 212′ and later may be rotated in the direction opposite that denoted by arrow 212′. This method comprises periodically reversing or otherwise alternating the rotational direction of the ball 210 about axis 212.

According to further embodiments of the invention, the seat 220 may be rotated in two directions about the second rotational axis 222. For example, the seat 220 may be rotated in a direction denoted by arrow 222′ and then later it may be rotated in a direction opposite that denoted by arrow 222′. This method comprises periodically reversing or otherwise alternating the rotational direction of the seat 220 about the second rotational axis 222.

In one embodiment, the angle β may be chosen such that the distance between edge 214 of ball 210 and a projection of edge 224 of seat 220 onto rotational axis 212 exceeds a threshold γ. In one embodiment, γ is chosen such that during the lapping process, the outer wall of the seat is rotated beyond the outer wall of the ball. In another embodiment, γ is chosen such that during the lapping process, the inner wall of the bore of the seat is rotated beyond the outer wall of the ball.

The angle α may be defined by the rotation of seat 220 about the third axis of rotation. One ray of the angle α may be defined by the position of the second axis of rotation when the seat is maximally articulated in one direction (222a) with respect to the third axis of rotation. The other ray of angle α may be defined by the position of the second axis of rotation when the seat is maximally articulated in the other direction (222b) with respect to the third axis of rotation.

In some embodiments of the invention, the seat 220 is articulated back and forth along the directions 222a and 222b with respect to the third axis of rotation. The speed of the back and forth movement may be slow or fast, constant or varied depending on the particular application. In still further embodiments, the seat 220 is not articulated so that the second axis 222 remains stations (notwithstanding the rotation of the seat 220 about this axis). Rather, the fixture 250, which is inserted into the bore 215 of ball 210, may be articulated. Thus, in these embodiments, it is the first rotation axis 212 that is articulated relative to the stationary second rotational axis 222 of the seat 220.

The articulated motion shown in the example embodiment of FIGS. 2A and 2B is a two dimensional planar movement of the seat relative to the ball. One skilled in the art with the benefit of this disclosure will recognize that mating of a ball with a seat as depicted in FIGS. 2A and 2B forms an articulation permitting the seat to move or articulate in three dimensions relative to the ball. Within the articulation, seat 220 includes a proximal end, which is in surface contact with the ball and a distal end which is the end opposite the proximal end. In another embodiment, the seat may be articulated in a three dimensional pattern such that the point on a cross section of the second rotational axis at the distal end of seat 220 moves in a circular or elliptical pattern. In still other embodiments, the articulating process may be a complex three dimensional movement of the seat relative to the ball. The articulating motion in combination with the axial rotations of the ball and the seats permit the entire spherical surface of the ball to contact the entire mating surface of the seat.

Match lapping a ball and seat may include adding lapping compound to facilitate forming a seal between a ball and a seat. Material from the ball and seat may be removed as the ball and seat are rubbed together using the method shown in FIG. 2. Consequently, match lapping may form a tighter seal between the ball and seat. The lapping process may begin by using a lapping compound with an abrasive of appropriate size. One skilled in the art with the benefit of this disclosure may determine the lapping compound for use during the lapping process. After a ball and seat have been sufficiently lapped using the starting lapping compound, the ball and seat should be washed to minimize contamination following a change in abrasive size. Next, an abrasive with a smaller particle size is added to the seal between the ball and the seat and the lapping method of FIG. 2 is again performed. The steps of washing, adding finer lapping abrasive, and lapping are repeated until a desired seal between a ball and seat is formed. For example, a bluing method may be used to test or measure the seal between a ball and seat. A bluing method may comprise adding a dye, e.g., blue dye, to the ball or seat and rubbing the ball and seat together in a fashion similar to that of normal valve operation. An inspection of the distribution of the dye across the ball and seat may reflect the spatial variation of the seal between the ball and seat.

In one embodiment, lapping compound may comprise a paste. In another embodiment lapping compound may comprise a powder. Grease, water, or other fluids may be added to the lapping powder to form a lapping grit. By using ever decreasing lapping abrasive, a tight seal between a ball and seat may be obtained. The absolute size differential between the ball and the seat during match lapping is not critical, because as the size of the lapping abrasive is reduced during the match lapping process, a tighter seal between a ball and seat may be formed. In one embodiment, three different lapping abrasive sizes may be used to form a tight seal between a ball and a seat.

The match lapping process may, in one embodiment, be performed at a rotational speed under 60 revolutions per minute (RPM). Preferably, the match lapping process may be performed at a rotational speed of about 10-20 RPM.

It is readily apparent to one skilled in the art with the benefit of this disclosure that the ball, the seat, or both may include a coating. For example, a ball may be coated with a layer of stellite or tungsten carbide. A seat may be coated with tungsten carbide or stellite or may have a solid tungsten carbide insert. In one embodiment, the finished ball or seat may include a coating layer of stellite or tungsten carbide about 0.003-0.005 inch thick. In another embodiment a seat may include an insert of stellite or tungsten carbide about 0.003-0.005 inch thick.

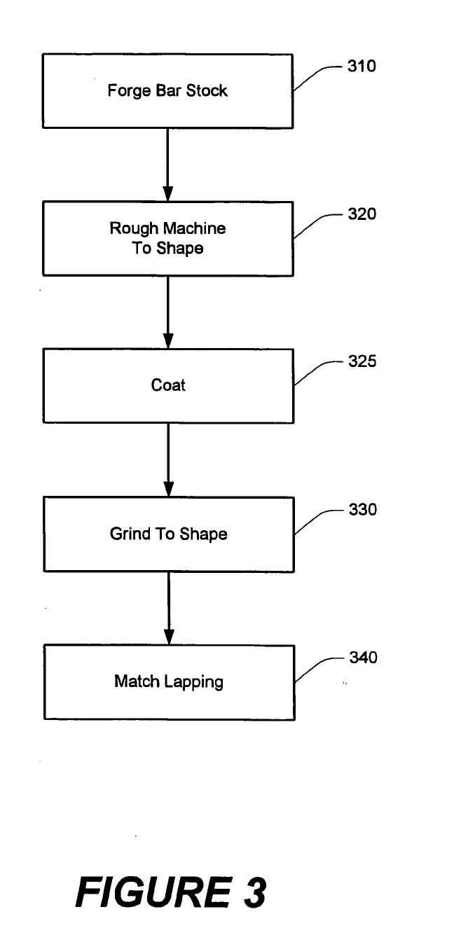

Turning to FIG. 3, a method for match lapping a coated ball and seat having a coating layer is depicted. Bar stock of appropriate size may be used to forge a ball and a seat (block 310). The forged bar stock may be rough machined to the respective shape for the ball or seat (block 320). In one embodiment, a ball and seat are undersized by the rough machine step by about 0.005-0.010 inches. Following rough machining, the ball and seat may be coated with a ceramic or alloy (block 325). In one embodiment, the coating layer may comprise stellite or tungsten carbide. The coating layer may be, in one example, about 0.010-0.020 inches thick, creating a ball and seat each having a coating layer about 0.005-0.010 inches thick. Next, the ball and seat may be ground to a more precise shape that is near the finished size (block 330). In one embodiment, the near finished size is about 0.001-0.002 inches oversize. Finally, match lapping may be used to form a ball and seat of finished size having a tight seal (block 340).

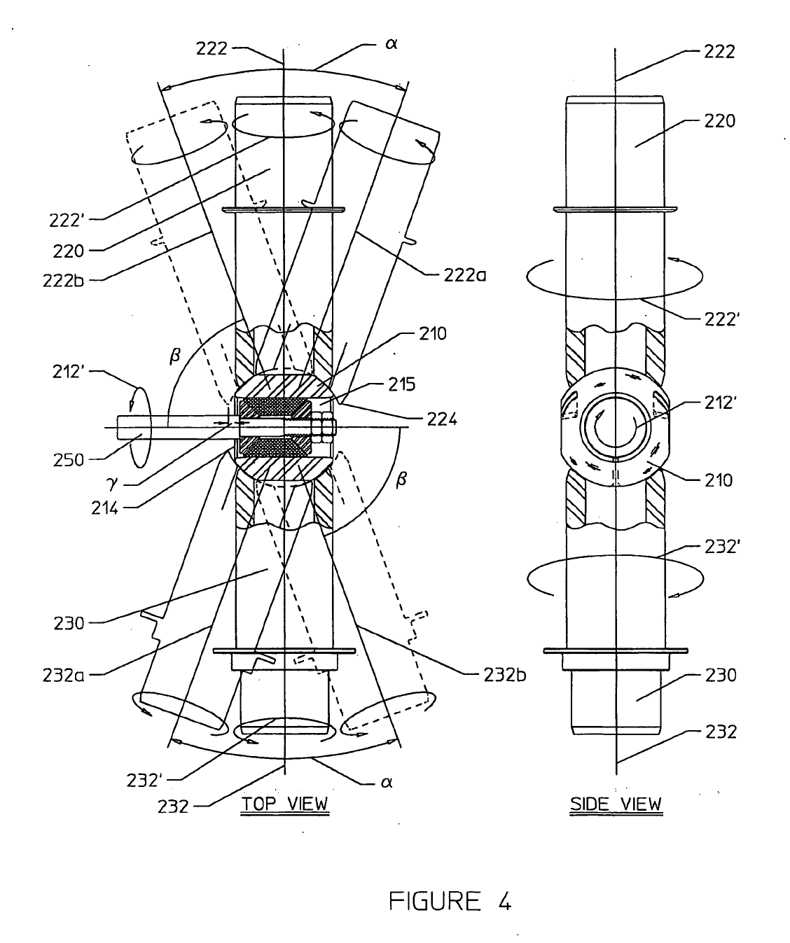

One skilled in the art with the benefit of this disclosure will recognize that the match lapping process may be performed using a ball and more than one seat. FIG. 4 depicts an embodiment for match lapping a ball with two seats. FIG. 4A is a top view and FIG. 4B is a side view showing the relative motion for match lapping a ball and two seats. FIGS. 4A and 4B are similar to FIGS. 2A and 2B with the addition of lower seat 230. Any one or more of the ball, the lower seat 230 and the upper seat 220 may include a coating.

The example lapping process shown in FIGS. 4A and 4B includes two axes of continuous rotation and one axis of partial rotation. Ball 210 may be rotated about a first rotational axis 212. Fixture 250 may be inserted into the bore 215 of ball 210, and fixture 250 may be rotated about a first rotation axis 212 in the direction denoted by arrow 212′. Upper seat 220 and lower seat 230 may be rotated about a second rotational axis 222 (or 232) in a direction denoted by arrow 222′ (or 232′). In the embodiment shown in FIGS. 4A and 4B, rotational axes 222 and 232 are assumed to be collinear. The second rotational axis may be perpendicular to the first rotational axis. Furthermore, upper seat 220 and lower seat 230 may be articulated within the angle denoted by α. For example, the seat may be partially rotated about a third axis, which may be perpendicular to the first and second axes. As a result, the angle formed by the intersection of the first and second rotational axis may range from about β to about α+β.

In one embodiment, the angle β may be chosen such that the distance between edge 214 of ball 210 and a projection of edge 224 of seat 220 onto rotational axis 212 exceeds a threshold γ. In one embodiment, γ is chosen such that during the lapping process, the outer wall of the seat is rotated beyond the outer wall of the ball. In another embodiment, γ is chosen such that during the lapping process, the inner wall of the bore of the seat is rotated beyond the outer wall of the ball.

The angle α may be defined by the rotation of seat 220 about the third axis of rotation. One ray of the angle α may be defined by the position of the second axis of rotation when the seat is maximally articulated in one direction (222a) with respect to the third axis of rotation. The other ray of angle α may be defined by the position of the second axis of rotation when the seat is maximally articulated in the other direction (222b) with respect to the third axis of rotation.

According to further embodiments of the invention, the upper seat 220 and lower seat 230 may be rotated about the second rotational axis 222 (or 232) (see FIGS. 4A and 4B) in two directions. Rather than continuous rotation in a single direction, the seat 220 may be rotated in two directions about the second rotational axis 222. For example, the seat 220 may be rotated in a direction denoted by arrow 222′ and then later it may be rotated in a direction opposite that denoted by arrow 222′. This method comprises periodically reversing or otherwise alternating the rotational direction of the seat 220 about the second rotational axis 222. Similarly, the lower seat 230 may be rotated in two directions about the second rotational axis 232.

The foregoing disclosure and description of the invention is illustrative and explanatory of preferred embodiments. It would be appreciated by those skilled in the art that various changes in the size, shape of materials, as well in the details of the illustrated construction or combination of features discussed herein maybe made without departing from the spirit of the invention, which is defined by the following claims. For example, those skilled in the art will appreciate that the rotational axis 222 of upper seat 220 and the rotational axis 232 of lower seat 230 in FIGS. 4A and 4B need not be collinear. Instead the rotational axis of upper seat 220 may be independent of the rotational axis of lower seat 230. Further, one skilled in the art with the benefit of this disclosure will recognize that the articulating motion may occur in either two or three dimensions permitting the entire spherical surface of the ball to contact the entire mating surface of the seat. Moreover, the articulating movement of a seat relative to a ball may occur by movement of one or both of the seat and ball. In another embodiment the direction of rotation of one or both of the ball or seat may be in the reverse direction from that shown in FIGS. 2 and 4.

The invention, therefore, is well adapted to carry out the objects and to attain the ends and advantages mentioned, as well as others inherent therein. While the invention has been depicted, described and is defined by reference to exemplary embodiments of the invention, such references do not imply a limitation on the invention, and no such limitation is to be inferred. The invention is capable of considerable modification, alternation and equivalents in form and function, as will occur to those ordinarily skilled in the pertinent arts and having the benefit of this disclosure. The depicted and described embodiments of the invention are exemplary only, and are not exhaustive of the scope of the invention. Consequently, the invention is intended to be limited only by the spirit and scope of the appended claims, giving full cognizance to equivalents in all respects.

1. A method for match lapping a ball valve assembly including a ball and a seat, the method comprising:
contacting the seat with the ball;
rotating the ball about a first rotational axis;
rotating the seat about a second rotational axis; and
changing an angle formed at the intersection of the first and second rotational axes.

2. A method for match lapping as claimed in claim 1, wherein the contacting the seat with the ball comprises mating the ball with the seat.

3. A method for match lapping as claimed in claim 1, wherein the rotating the ball about a first rotational axis comprises changing the direction of rotation.

4. A method for match lapping as claimed in claim 1, wherein the rotating the ball and the rotating the seat comprise rotating at a rotational speed between about 10 and about 60 revolutions per minute (RPM).

5. A method for match lapping as claimed in claim 1, wherein the rotating the seat about a second rotational axis comprises changing the direction of rotation.

6. A method for match lapping as claimed in claim 1, wherein changing an angle formed at the intersection of the first and second rotational axes comprises increasing the angle and decreasing the angle.

7. A method for match lapping as claimed in claim 1, further comprising rough machining the ball and the seat to within about 0.010 and about 0.020 inches of the desired finished sizes.

8. A method for match lapping as claimed in claim 1, further comprising grinding the ball and the seat to within about 0.001 and about 0.002 inches of the desired finished sizes.

9. A method for match lapping as claimed in claim 8, wherein the grinding is performed to within an RMS of about 8.

10. A method for match lapping as claimed in claim 1, further comprising continuing the rotations of the ball and seat in contact with each other and continuing the changing of the angle between the first and second axes until between about 0.001 and about 0.002 inches of material is removed from one of the ball and the seat.

11. A method for match lapping as claimed in claim 1, further comprising:
applying a first lapping compound comprising an abrasive of a first size to one of the seat and the ball;
washing first lapping compound from the seat and the ball;
applying a second lapping compound comprising an abrasive of a second size to one of the seat and the ball, wherein the first size is larger than the second size; and
washing the second lapping compound from the seat and the ball.

12. A method for match lapping as claimed in claim 1, further comprising coating one of the ball and the seat.

13. A method for match lapping as claimed in claim 12, wherein the coating comprises coating with a material comprising one of stellite and tungsten carbide, wherein the coating layer is about 0.005 to about 0.020 inches thick.

14. A method for match lapping a ball valve assembly including a ball and a seat, the method comprising:
rough machining the ball and the seat to within about 0.010 and about 0.020 inches of the desired finished sizes;
grinding the ball and the seat to within about 0.001 and about 0.002 inches of the desired finished sizes;
contacting the seat with the ball;
rotating the ball about a first rotational axis at a rotational speed between about 10 and about 60 revolutions per minute (RPM) and changing the direction of rotation;
rotating the seat about a second rotational axis at a rotational speed between about 10 and about 60 revolutions per minute (RPM) and changing the direction of rotation;
applying a first lapping compound comprising an abrasive of a first size to one of the seat and the ball;
washing first lapping compound from the seat and the ball;
applying a second lapping compound comprising an abrasive of a second size to one of the seat and the ball, wherein the first size is larger than the second size;
washing the second lapping compound from the seat and the ball; and
changing an angle formed at the intersection of the first and second rotational axes by increasing the angle and decreasing the angle.

15. A ball valve assembly having a ball and a seat manufactured by a method, the method comprising:
contacting the seat with the ball;
rotating the ball about a first rotational axis;
rotating the seat about a second rotational axis; and
changing an angle formed at the intersection of the first and second rotational axes.

16. A ball valve assembly manufactured by the method as claimed in claim 15, wherein the rotating the ball about a first rotational axis comprises changing the direction of rotation, wherein the rotating the seat about a second rotational axis comprises changing the direction of rotation, and wherein changing the angle formed at the intersection of the first and second rotational axes comprises increasing the angle and decreasing the angle.

17. A ball valve assembly manufactured by the method as claimed in claim 15, wherein the rotating the ball and the rotating the seat comprise rotating at a rotational speed between about 10 and about 60 revolutions per minute (RPM).

18. A ball valve assembly manufactured by the method as claimed in claim 15, further comprising:
rough machining the ball and the seat to within about 0.010 and about 0.020 inches of the desired finished sizes;
grinding the ball and the seat to within about 0.001 and about 0.002 inches of the desired finished sizes, wherein the grinding is performed to within an RMS of about 8; and
continuing the rotations of the ball and seat in contact with each other and continuing the changing of the angle between the first and second axes until between about 0.001 and about 0.002 inches of material is removed from one of the ball and the seat.

19. A ball valve assembly manufactured by the method as claimed in claim 15, further comprising:
applying a first lapping compound comprising an abrasive of a first size to one of the seat and the ball;
washing first lapping compound from the seat and the ball;
applying a second lapping compound comprising an abrasive of a second size to one of the seat and the ball, wherein the first size is larger than the second size; and
washing the second lapping compound from the seat and the ball.

20. A ball valve assembly manufactured by the method as claimed in claim 15, further comprising coating one of the ball and the seat with a material comprising one of stellite and tungsten carbide, wherein the coating layer is about 0.005 to about 0.020 inches thick.
